(19) United States
(12) Patent Application Publication
(10) Pub. No.: US 2019/0126525 A1
(43) Pub. Date: May 2, 2019

(54) INJECTION TOOL AND METHOD TO SEAL INSERT PARTS

(71) Applicant: ZF Friedrichshafen AG, Friedrichshafen (DE)

(72) Inventors: Stefan Schaub, Kups (DE); Markus Dörig, Speichersdorf (DE)

(73) Assignee: ZF Friedrichshafen AG, Friedrichshafen (DE)

(21) Appl. No.: 16/172,239

(22) Filed: Oct. 26, 2018

(30) Foreign Application Priority Data
Oct. 27, 2017 (DE) 102017219325.5

(51) Int. Cl. B29C 45/14; B29C 33/00

(52) U.S. Cl. CPC B29C 45/14418; B29K 2871/00; B29C 2045/14934; B29C 33/0044

(57) ABSTRACT

An injection molding tool is provided, comprising a base carrier that is suitable to accommodate an insert component, wherein at least one separate part of the base carrier forms a contact surface with the insert component after it has been inserted into the base carrier, wherein at least the contact surface features a high-temperature material. Furthermore, a method for the sealing of insert components is provided.

### RELATED APPLICATION

This application claims the benefit and priority of German Patent Application DE 10 2017 219 325.5, filed Oct. 27, 2017, which is incorporated by reference herein in its entirety.

### TECHNICAL FIELD

The present invention relates to an injection molding tool and a method for the sealing of insert components.

### BACKGROUND

To protect components, these are often equipped with a lid and are overmolded with a mass, which protects the components from a penetration of external influences. This is e.g. carried out by means of an injection molding tool. To accomplish this, an insert component, which is usually a metal sheet, is inserted into the space that is provided for the injection molding tool. Then it is overmolded with a flowable plastic compound. The contact surfaces on the injection molding tool are hereby used for the sealing of the insert component. A disadvantage of the sealings that are known thus far is, that they either do not completely seal or, when they provide a better sealing, that they are not able to withstand the high temperatures during the injection molding process. Furthermore, larger excess molding often occurs during the injection molding procedure, resulting in undesired burr formations.

It is thus one objective of this invention to provide an injection molding tool and a method for the sealing of insert components, by means of which the mentioned disadvantages are overcome.

In accordance with the invention, this objective is achieved by means of the characteristics of the independent patent claims. Advantageous embodiments are subject-matter of the dependent claims.

An injection molding tool is provided, comprising a base carrier that is suitable to accommodate an insert component, wherein at least one separate part of the base carrier forms a contact surface with the insert component after it has been inserted into the base carrier, herein at least the contact surface features a high-temperature material.

By replacing the previously known contact surface with a high-temperature material, a significantly lower contact pressure can be used than it was used for methods that are known thus far. An improved sealing of the insert component can thus be achieved by means of an injection molding with the flowable mass, e.g. with thermoset plastic. Also, a compensating of uneven surfaces on the insert components can be accomplished due to the temperature characteristics of the high-temperature materials.

In one embodiment, at least the separate part of the base carrier is surrounded by the high-temperature material.

In one embodiment, the base carrier consists of at least two components that can be connected to each other, one of which is the separate part, and wherein the separate part is made of the high-temperature material.

By surrounding the contact surface with a high-temperature material or by providing a second part as an attachable cover so to speak, an already existing injection molding tool can be retrofitted. By means of the two-part production of the contact area of the injection molding tool, its production is simpler.

In one embodiment, the high-temperature material features a predetermined thickness. The thickness is selected in such a way, that the desired characteristics, i.e. a sealing at the lowest possible contact pressure, can be realized.

A method for the sealing of insert components is furthermore provided, wherein at least one insert component is hereby inserted into the described base carrier of the injection molding tool, and a pressure is exerted onto it in a further step, and in another step, it is overmolded with a flowable mass. The maximum contact pressure between the injection molding tool and the insert component is hereby selected in such a way, that at least one sealing section of the insert component is protected against penetration of the flowable mass during the injection molding procedure.

In one embodiment, the base carrier can be moved hydraulically. The contact pressure is thereby adjustable for the sealing.

In one embodiment, the high-temperature material is PEEK. In one embodiment, the flowable mass is a thermoset. In one embodiment, a circuit board equipped with electronic and/or electrical components is arranged within the at least one insert component.

When using the high-temperature material, in particular PEEK, it is advantageous that a significantly lower contact pressure can be used than in methods that are known thus far. An improved sealing of the insert component can thus be achieved by means of the overmolding with e.g. the thermoset, as well as a compensating of uneven surfaces on the insert component due to the temperature characteristics.

Further characteristics and advantages of the invention can be derived from the following description of embodiments of the invention, from the figures of the drawings that depict details according to the invention, and from the claims. The individual characteristics can be implemented individually by themselves or as a plurality in any combination in any variant of the invention.

### BRIEF DESCRIPTION OF THE DRAWINGS

Preferred embodiments of the invention are described in detail in the following by means of the attached drawings.

FIG. 1 shows a schematic side view of an injection molding tool with a contact surface made of PEEK and an insert component that is arranged on it in accordance with one variant of the present invention.

FIG. 2 shows the schematic side view depicted in FIG. 1 after the overmolding of the insert component with thermoset.

FIG. 3 shows a schematic flow chart of the method in accordance with a variant of the present invention.

### DETAILED DESCRIPTION

In the following description of the figures, identical elements or functions are provided with the same reference signs.

A thermosetting plastic is often used as flowable mass for the injection molding of insert components, because it turns very low viscous during the injection molding process and can therefore be used very well for filling thin-walled areas. However, it also flows very easily into areas that should not be overmolded, i.e. where no thermosetting plastic should be found after the injection molding process. Such areas are e.g. electrical or electronic components, over which the thermosetting plastic flows during the overmolding process, since these are not completely sealed from the contact surface. This can happen since uneven surfaces can appear in the insert component due to manufacturing tolerances, which cannot be fully sealed by the metallic contact area that was used thus far. The inflow into undesired areas calls for an extensive reworking. This is a problem especially when electrical or electronic components are overmolded, since these should be stressed as little as possible mechanically, in order to prevent damage or destruction.

To achieve a better sealing, a high contact pressure is used between the base carrier of the injection molding tool, into which the insert component is arranged, and the insert component. On the other hand, this is a disadvantage for especially electrical or electronic components, since these are sensitive to pressure. The force that is referred to as contact pressure or pre-tensioning is the force that is exerted onto the insert components during the injection molding process e.g. with thermosetting plastic, in order to be sealed in such a way that an overmolding of undesired areas with thermosetting plastic is prevented. Particularly the base carrier can be arranged to be hydraulically movable.

So far, the sealing of pressure-sensitive components, in particular circuit boards with electrical or electronic components mounted on it, is not solved optimally. As a solution, it is thus suggested to replace the contact surfaces of the base carrier of the injection molding tool, which serve for the sealing of the insert components, with a technical high-temperature material. The use of PEEK, or polyetheretherketone is advantageous in this case. Although this plastic material is as hard as steel, it can absorb small uneven surfaces in a temperature range of a thermoset tool of approx. 160° C. As a result, when compared to conventional methods, a reduced contact pressure can be used without impairing the sealing effect. The sealing effect is even enhanced by the use of a technical high-temperature material such as PEEK, although the contact pressure is reduced. This is a result particularly of the thermal characteristics of the material.

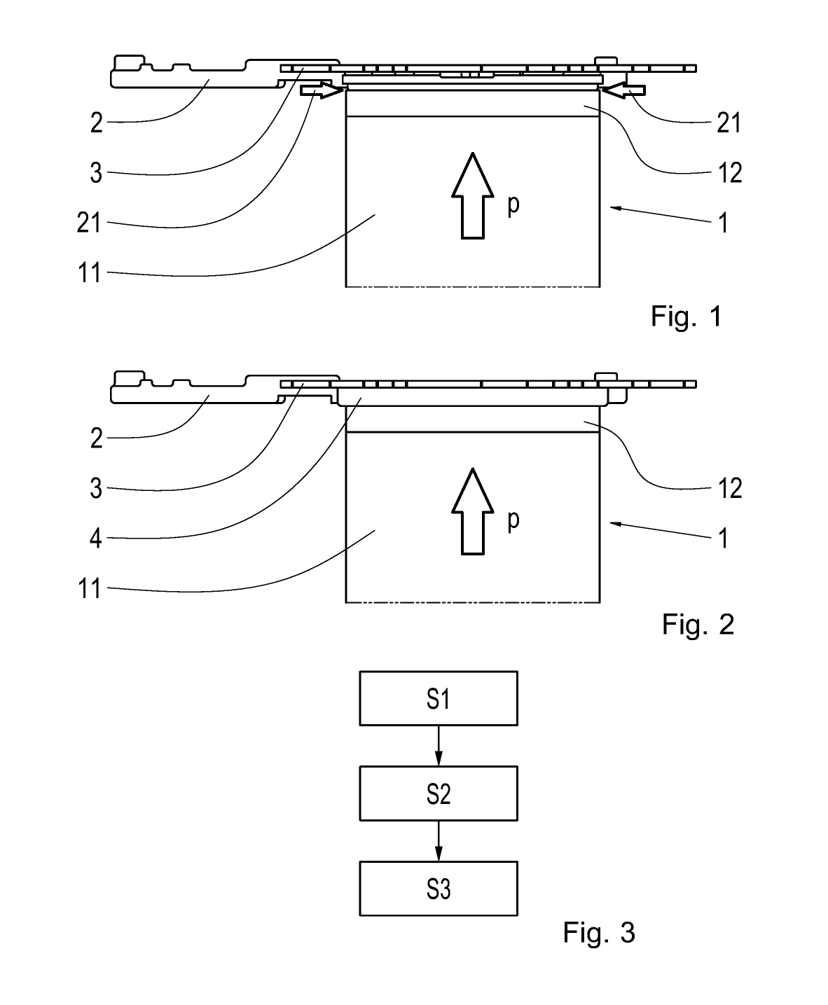

FIG. 1 shows a version of the injection molding tool comprising a base carrier 1, in which the contact surface 12 features the technical high-temperature material that was described above between the insert component 2 and the base carrier 1 of the injection molding tool. A circuit board 3 is furthermore shown within the insert component 2, which is normally populated with pressure-sensitive electrical and/or electronic components. The area between base carrier 1 and insert component 2 is referred to with reference sign 21, which is to be sealed against the flowable mass, which is generally a thermosetting plastic, in short, the sealing area 21. Conventionally, the base carrier 1 is pressed against the insert component 2 with high contact pressure p without the buffer layer made of the technical high-temperature material in line with the invention. The contact pressure has to be selected so high in this case, that if possible no thermosetting plastic flows into the area that is to be sealed, but that existing pressure-sensitive components are also not destroyed. By means of using the technical high-temperature material, particularly advantageous is PEEK due to its thermal characteristics, a significantly lower contact pressure p can be used. At the same time, this material can compensate uneven surfaces in the insert component 2 at the temperatures of approximately 160° C. which are necessary for the injection molding process, so that less burr formations will occur due to an inflow of flowable mass into undesired areas. In FIG. 2, the insert component 2 is shown, which is overmolded with thermosetting plastic at the desired locations.

As it is schematically indicated in the FIGS. 1 and 2, part 12 of base carrier 1, which is to be brought into contact with the area of the insert component 2 that is to be injection molded, may be formed as a separate part 12 of the injection molding tool or may be surrounded by a high-temperature material. This separate part 12 is then placed on the remaining part 11 of base carrier 1 and thus forms the buffer layer, which makes it possible to reduce the contact pressure p on the insert component 2 and at the same time to compensate uneven surfaces due to the thermal characteristics, so that an improved sealing against the flowable mass is achieved.

The separate area 12 may thus be formed in one embodiment as a separate component which is placed on the remaining part 11 of base carrier 1, e.g. in form or a lid. In another variant it is possible that the upper, separate part 12 of basic carrier 1 can be surrounded with the technical high-temperature material, e.g. coated or overmolded. In any case, it is necessary that the separate part 12 of basic carrier 1 that is made of the technical high-temperature material features a thickness, by means of which the advantageous characteristics of the separate part 12 can be used, i.e. in particular the exerting of a lower pressure p on the insert component 2 while achieving an increased sealing effect at the same time. The technical high-temperature material is furthermore to be selected in such a way, that it is thermally stable in the temperature range which is used for the injection molding, but that it can still flow to a certain degree. At lower temperatures it should be hard. A very suitable material is PPEK, or polyetheretherketone.

FIG. 3 shows a schematic sequence of the method for the injection molding process of an insert component 2 with a described injection molding tool. First, at least one insert component is inserted into the described base carrier 1 of the injection molding tool (S1). Then, the insert component 2 is subjected to a contact pressure p (S2), so that it is sealed against the flowable mass that is applied in the next step (S3). The maximum contact pressure p between the contact surface of the separate part 12 of base carrier 1 and the insert component 2 is hereby selected in such a way, that at least one sealing section 21 of the insert component 2 is protected against penetration of the flowable mass during the injection molding process. Maximum means that the contact pressure p is chosen in such a way that a sealing against the flowable mass is provided, but that pressure-sensitive components are not damaged or destroyed. As it was already described, the advantage of the use of a base carrier 1 with a separate part 12, which features a technical high-temperature material, in particular PEEK, that a significantly lower pressure p can be used while achieving an increased sealing effect at the same time.

### LIST OF REFERENCE SIGNS

1 Base carrier of the injection molding tool
11 Remaining/lower part of the base carrier
12 Separate part of the base carrier
2 Insert component
21 Sealing section
3 Circuit board
4 flowable mass

1. An injection molding tool, comprising:
a base carrier configured to accommodate an insert component, wherein at least one part of the base carrier forms a contact surface with the insert component after it has been inserted into the base carrier, and wherein at least the contact surface includes a high-temperature material.

2. The injection molding tool according to claim 1, wherein at least the part of the base carrier is surrounded by the high-temperature material.

3. The injection molding tool according to claim 1, wherein the base carrier comprises at least two components that can be connected to each other, one of which is the part, and wherein the part is made of the high-temperature material.

4. The injection molding tool according to claim 1, wherein the high-temperature material features a predetermined thickness.

5. The injection molding tool according to claim 1, wherein the high-temperature material is polyetheretherketone (PEEK).

6-9. (canceled)

10. A method for sealing at least one insert component, wherein the insert component includes a base carrier that configured to accommodate the insert component, wherein at least one part of the base carrier forms a contact surface with the insert component after it has been inserted into the base carrier, the method comprising:
exerting a pressure onto the insert component; and
overmolding the insert component with a flowable mass, wherein the maximum contact pressure between an injection molding tool and the insert component is configured such that at least one sealing section of the insert component is protected against penetration of the flowable mass during injection molding.

11. The method of claim 10, wherein the contact surface is formed with a high-temperature material.

12. The method of claim 11, wherein the high-temperature material is polyetheretherketone (PEEK).

13. The method of claim 10, wherein a circuit board equipped with eat least one electric component is arranged within the insert component.

14. An injection molding tool, comprising:
a base carrier; and
an insert component,
wherein the base carrier forms a contact surface,
wherein the insert component abuts the contact surface after it has been inserted into the base carrier, and
wherein the contact surface includes a polyetheretherketone (PEEK).

15. The injection molding tool according to claim 14, wherein the contact surface is fully formed by the polyetheretherketone.

16. The injection molding tool according to claim 14, wherein the base carrier comprises at least two components that can be connected to each other, wherein a first component of the at least two components forms the contact surface, and wherein the first component is surrounded by the polyetheretherketone.
